(19) United States
(12) Patent Application Publication
(10) Pub. No.: US 2007/0279226 A1
(43) Pub. Date: Dec. 6, 2007

(54) Security Monitoring System

(75) Inventors: Howard William Whitesmith, New South Wales (AU); Stephen Russell Taylor, Cambridge (GB); Charles Robert Sims, Hertfordshire (GB); Stephen Charles Sims, Duxford (GB)

Correspondence Address: BOND, SCHOENECK & KING, PLLC, ONE LINCOLN CENTER, SYRACUSE, NY, 13202-1355, US

(73) Assignee: TAGTEC LIMITED, Cambridge (GB)

(21) Appl. No.: 11/749,392

(22) Filed: May 16, 2007

(30) Foreign Application Priority Data
May 30, 2006 (GB) 0610558.9

(51) Int. Cl. G08B 13/14; G08B 1/08

(52) U.S. Cl. 340/572.1; 340/539.23

(57) ABSTRACT

An RFID transceiver tag is proposed for use in a monitoring system for detecting a change in position of the tag relative to an associated RFID tag or to the environment surrounding or between the tags. The transceiver tag has a detector for detecting a characteristic of a signal transmitted between the transceiver tag and the associated RFID tag and for creating a trigger signal if the detector detects that the characteristic has changed beyond a predetermined extent; and a transmitter for transmitting a signal to a remote controller on receipt of the trigger signal from the detector.

### CLAIM OF PRIORITY

The present application claims priority to Great Britain Patent Application Number 0610558.9, filed May 30, 2006, the entirety of which is hereby incorporated by reference.

### BACKGROUND OF THE INVENTION

The present invention relates to a security monitoring system and, more particularly, to a wireless security system, more particularly for use in building or asset security monitoring and to the various components of such a system.

In PCT patent application WO-A-00/19235 there is described and claimed system for monitoring the position of one or more RFID tags, the system comprising one or more detectors incorporating means for receiving signals from RFID tag for detecting changes in the range of an RFID tag from the detector or detectors; and control means comparing the signals received from the RFID tag at different times to detect a change in a range of an RFID tag and triggering an alarm if a detected change in the range of the RFID tag exceeds a predetermined threshold. This is now European patent 1112512 and U.S. Pat. No. 6,577,238.

Such a system may include RFID tags which have circuitry arranged to emit short bursts of RF energy at periodic intervals, and the or each detector may include circuitry for detecting changes in the periodic interval at which energy is transmitted by the or each tag. The or each detector preferably includes circuitry for predicting the time of receipt of a burst of energy from that tag and for triggering an alarm if the time of actual receipt varies from the predicted time of receipt by more than a predetermined interval and/or if the rate if change in the periodic interval at which energy is transmitted by a tag is outside a predetermined range. Alternatively, or additionally, the detector(s) may include circuitry for analysing changes in the rate of receipt of bursts of energy from a tag and for triggering an alarm if the rate of change is more than a predetermined level.

Systems of this type may be utilised, for example, in the home, for ensuring the security of components such as valuable equipment such as televisions, personal computers and the like, or other valuable items such as paintings, furniture etc which may be relatively easily removed from their normal location. Movement of a detector in such a system is recognised by the central controller and an appropriate alarm signal is given.

There is a need, however, to simplify installation and reduce installation costs, at the same time making the system easy to use in the home environment.

### SUMMARY OF THE INVENTION

According to the invention there is provided an RFID transceiver tag for use in a monitoring system for detecting a change in position of the tag relative to an associated RFID tag or the environment surrounding or between the tags, the transceiver tag having
1. a detector for detecting a characteristic of a signal transmitted between the transceiver tag and the associated RFID tag and for creating a trigger signal if the detector detects that the characteristic has changed beyond a predetermined extent; and
2. a transmitter for transmitting a signal to a remote controller on receipt of the trigger signal from the detector.

The invention enables a system to be set up simply and quickly and allows monitoring of objects instead of environments. Such a system is ideal for households that are unable or unwilling to install a permanent household alarm system for the area. Typical scenario's would be student and rented accommodation where the system would be used to protect several high value items in a small physical area.

The system, as described below provides the following functional attributes:
1. Portability in situations where the room being monitored may change several times per year, for example student accommodation;
2. Robustness against environmental changes, such as temporarily moving an object slightly to clean it without the alarm sounding;
3. Ease of use and installation to the extent that user interaction consists of only a few simple steps in order to have a fully operable system.

The detector may be arranged to vary the extent of change of the predetermined characteristic at which it creates the trigger signal, for example, the received power level of the signal at which it creates the trigger signal may be self-adjusted to increase to avoid premature triggering.

Preferably, the transceiver tag is arranged to monitor the characteristic of the signal from the associated RFID tag.

The transceiver tag may include a second transmitter for transmitting a ranging signal to the associated RFID tag, and the detector is then arranged to detect the receipt of a signal from the associated RFID tag indicating that a characteristic of the ranging signal has changed beyond the predetermined extent. Again, the second transmitter may be arranged to vary the characteristic of the ranging signal and again it may be the power level which is adjusted.

The invention also includes a monitoring system for detecting a change in position of an item relative to another item or a change in the environment, the system including
1. a first RFID transceiver tag as defined above; and
2. a second RFID tag arranged to transmit a signal to the first transceiver tag, and
3. wherein the detector of the first transceiver tag detects a characteristic of the signal transmitted by the second RFID tag.

In an alternative system, the system includes
1. a first RFID transceiver tag; and
2. a second RFID tag having
   i. a detector for detecting a characteristic of the ranging signal transmitted from the first RFID transceiver tag to the second RFID tag and for creating a sensing signal if the detector detects that the characteristic has changed beyond a predetermined extent, and
   ii. a transmitter for transmitting the sensing signal to the first RFID transceiver tag on receipt of the trigger signal from the detector, and
3. wherein the detector of the first RFID transceiver tag is arranged to create the trigger signal on receipt of the sensing signal.

Preferably, a controller is arranged to detect receipt of the trigger signal from the first RFID transceiver tag and generate an alarm signal on receipt thereof. The trigger signal may be received directly from the RFID transceiver tag.

Alternatively the detector may report the alarm condition to the controller via another tag in the system where it cannot communicate directly to the controller due to the distances involved, the controller having first set up the network to allow such indirect communication and the other tag in the system then reporting the alarm condition to the main controller.

One or more additional identical RFID tags may also be provided as desired.

In such a monitoring system
1. the controller may be switchable between first, second, third, fourth and fifth states; the first state being an “off” state, the second state being one in which a first signal is broadcast to the RFID tags to cause an uninitialised tag within range of the controller to be initialised to a specific relationship with the controller, the third state being one in which initialised RFID tags are provided with system information by the controller; and the fourth state being one in which the controller provides a control signal in turn to each initialised RFID tag to cause the RFID tag to attempt to pair with another RFID tag;
   i. the RFID tags being arranged such that, on receipt of the control signal from the controller, the RFID tag transmits a pairing signal and, if a pairing response signal is received from another RFID tag, confirms the pairing with the other RFID tag and to the controller, and such that on receipt of a pairing signal from a first RFID tag the other RFID tag transmits a pairing response signal to the first RFID tag, and thereafter, on receipt of the confirmation of pairing signal from the first RFID tag, switches to a state in which it will not respond to a control signal received from the controller, and thereafter the first RFID tag monitors for detection of a characteristic of a signal transmitted between the first RFID tag and the other RFID tag; and
   ii. the fifth state of the controller providing an armed state in which it monitors for receipt of the trigger signal from the first RFID tag of the or each pair of RFID tags.

By utilising identical RFID transceiver tags, the complexity of the system can be reduced both as far as numbers of different components is concerned and as far as setting-up by the operator is concerned.

A system as defined above may be adapted to sense a change in the environment between or surrounding two or more tags. When two or more tags are placed a fixed distance apart the transmission between the tags can be affected by an external object or force. The system will behave as if one tag has moved relative to another and an alarm condition can be activated if the characteristic of transmission signal between the tags has changed beyond a predetermined extent. An example of an application of this use is to fix two or more tags in one unit and use the unit to detect the proximity of a metal object such as a motor vehicle.

### BRIEF DESCRIPTION OF THE DRAWINGS

An example of an RFID transceiver tag and a monitoring system including plural such tags, according to the invention, will now be described with reference to the accompanying drawings, in which:

FIG. 1 shows, diagrammatically, the component elements of each of three RFID tags used in the system;

FIG. 2 shows, diagrammatically, the three RFID tags and a controller; and

FIG. 3 shows, diagrammatically, the component elements of the controller;

### DETAILED DESCRIPTION

The monitoring system of this example utilises three RFID tags 10A, 10B, 10C. Each is identical in components, but is distinguishable from the other RFID tags by a tag ID held in memory within the tag (see below).

The controller 20 (see FIG. 3) is provided in the form of a housing 200 containing the operative components and is pluggable into a conventional UK mains socket using the usual connector terminals 201 in order to receive power which charges an internal battery 202 which powers the controller 20. The controller includes a key switch 203 used to select the system's mode; a pair of LED's 204, 205 indicating controller power and radio activity respectively; a sounder unit 206 to deliver an audible alarm; a sliding power switch 207 to control delivery of power to a TTP (The Technology Partnership) Matrix RFID module 209 containing a microprocessor 210, transmitter 211, receiver 212 and antenna 213 from a battery cell 208.

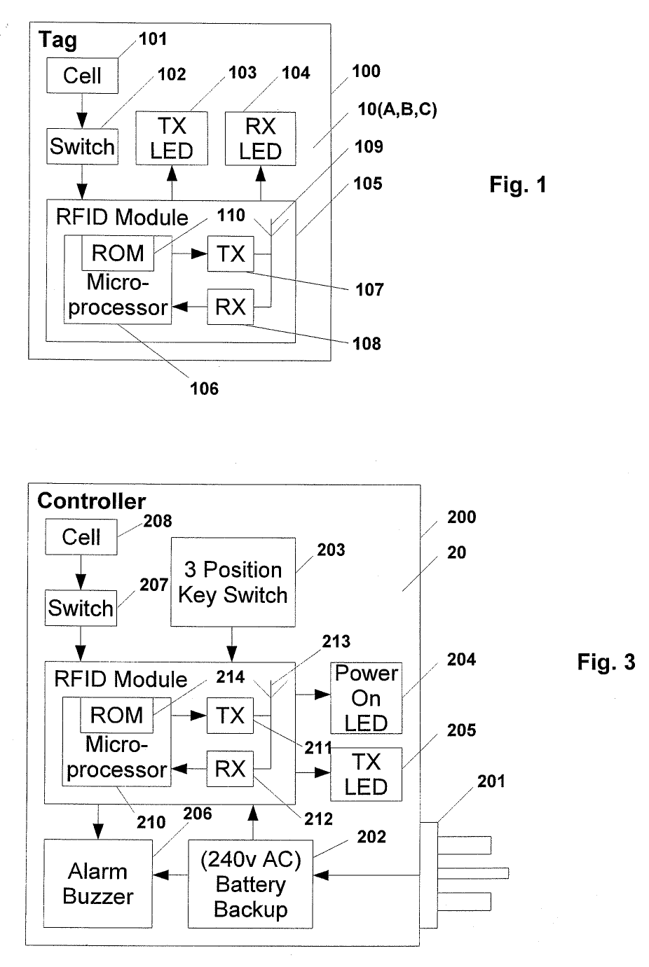

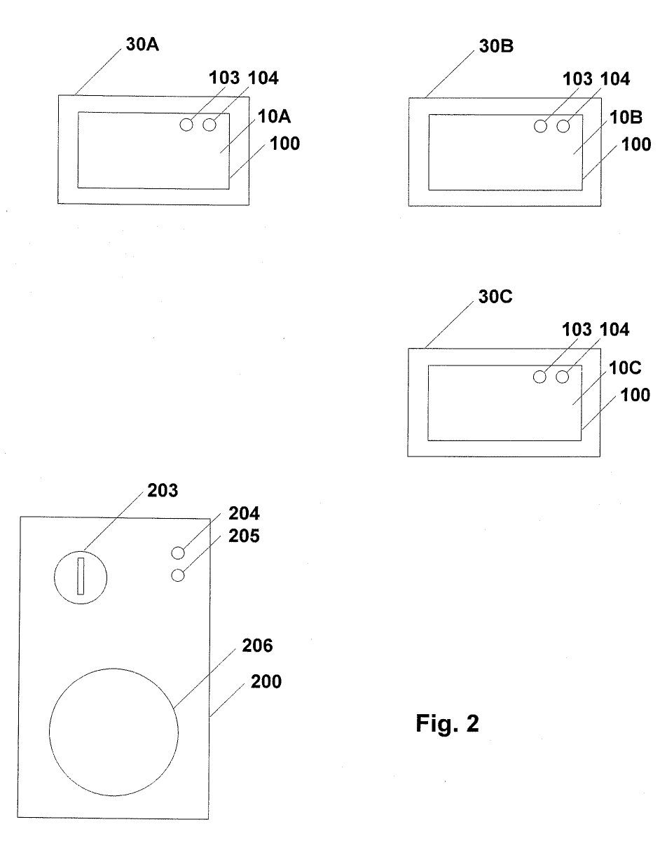

TTP's Matrix RFID technology consists of a hardware and software platform encompassing an off-the-shelf high frequency transceiver 211,212 with integrated microcontroller 210 operating in the instrument, scientific and medical band (˜433 MHz). The Matrix RFID module 209 interfaces to the key switch 203, sounder 206 and LED's 204, 205 and its microcontroller 210 runs a basic Matrix stack and a specially written controller application. It is capable of operating in 433, 868 and 915 MHz bands, selectable in software. Four different transmitter power levels are usable, configurable through software. In addition the controller 20 has 4K Flash ROM 214, containing the Matrix stack software (device driver level) and the controller application software (application level). Each RFID tag (see FIG. 1) has a casing 100 containing a Matrix battery cell 101, a sliding power switch 102 isolating the MCC, two LED's 103, 104, indicating transmit and receive radio activity respectively between tags and the controller system-wide broadcast, as well as a Matrix RFID module 105 with integrated microprocessor 106 transmitter 107, receiver 108 and antenna 109 powered by the cell 101. The Matrix RFID module 105 internally interfaces to the LED's 102, 103 and runs the basic Matrix stack and a specially written tag application to allow the tag to function in either of two modes, detector mode or tag mode (as further described below). The tag 10 is powered by the battery cell 101 which is a lithium battery.

The microprocessor 106 includes a ROM110 containing the stack and application software.

In this example, three tags 10A, 10B, 10C are provided for a system for securing three articles 30A, 30B, 30C against unauthorised movement (e.g., theft) and set up of the system is as follows.

There are four possible states for the system to be in and these are:
1. Installation (tag ‘adoption’)—The controller 20 can initialise new uninitialised tags 10 into it's group. (In a production system, the tags would only be able to be initialised to a particular controller once and the range of the controller. The tags are only able to be initialised to a single controller once in their lifetime and to prevent blank tags in the vicinity from being accidentally initialised, the transmitting range of the controller is reduced to a few centimetres;
2. Disarmed—The controller 20 is asleep and tags 10 may be moved without the alarm 206 sounding;
3. Armed—The controller 20 is monitoring the tags for unauthorised movement. (The flashing LED 204 on the controller indicates that the controller has been armed;
4. Triggered—Movement of tags 10 in relation to one another or disabling any of the tags causes the controller to trigger the alarm 206. These are detailed in the various use case sections of this document.

The alarm can be reset using the arming key (not shown) in the key switch 203 by placing the controller into the disarmed state. The Installation, Armed and Disarmed states are selected using the three different positions of the key switch 203. The controller's LED 204 indicates which mode is currently selected by flashing several times per second in the Installation state and once every two seconds in all other states.

The four system states are described below.

### Initialisation (Adopt Tags State

This is the initial state of the system. The controller 20 is plugged in and switched on with the key switch 203 in its “Adopt Tags” position. At this point the controller knows nothing about the tags 10. The controller broadcasts a message (see below) periodically on very low power that advertises the next available tag ID, starting at “1”. Any tag 10 that has previously not been adopted by the controller responds to this broadcast with a message accepting the adoption. The controller 20 then responds to the tag confirming its acceptance of the tag into its group and updates its own internal count of adopted tags in order that it can broadcast to the next tag ID. In a production system, the tags have ID's set at manufacture and the controller enumerates the tags with a local group ID or something. This prevents collision because the controller individually addresses the tags to confirm their local group ID. Each tag 10 as it is adopted now leaves it's uninitialised state and enters a disarmed state while the controller 20 continues to advertise the next available tag ID. The process continues until the controller 20 is set to enter its disarmed mode (by the key switch 203) or the number of adopted tags 10 reaches the maximum allowed for in the system (this can vary from system to system as desired).

All messages are in the format: <Source Address><Target Address><Type of Message><Some Data (Type of Message Dependent)>

For example the Initialisation (adopt) message from controller to tags would be: [From:Controller][To:All Tags][Type:Adopt][Data:Next Available Tag ID]

As all messages follow the same format, it is just the value of the fields that change. Messages can be one to one instead of broadcast (as with the comms between two tags in a pair). The Data component is dependent on the type of message, for example with the “Adopt” message, the data is the address that the tag may take. In the “Synchronise” message, the Data component represents the state of the system (disarmed, pair up, trio up, armed).

At this point, there is no distinction between the tags 10; they are all just tags assigned to the controller 20. The tags 10A, 10B, 10C can all be in range when the controller is powered up or brought into range one at a time. The internal system numbering of the tags is unimportant to the user, but the controller 20 has enumerated them sequentially, for example the first uninitialised tag 10A would have been enumerated as number 1, the second 10B as number 2 and the third 10C as number 3. This allows for the system to have been configured previously but then set back into “Adopt tags” mode and further tags added if needed.

### Disarmed State

The key switch 203 on the controller 20 is turned to the “Disarmed state” position and the controller sends out periodic broadcast messages to all tags 10A, 10B, 10C. These broadcast messages are sent out both in the Disarmed mode and the Armed mode and are used to convey system state information (Disarmed, Pair Up, Trio Up, Armed) to all the tags. In the disarmed mode, this just serves to confirm to the tags that they are all disarmed.

It is in this mode that tags are placed on the articles to be secured with a minimum of at least two tags within close proximity of each other. Each of the tags 10A, 10B, 10C is secured to the corresponding article 30A, 30B, 30C in a suitable manner. This may be by way of adhesive or some other permanent fixing or lockable fixing method. There can obviously be many more than two tags together, the pairing/trioing algorithm discussed in the next section separates them all into pairs.

The key switch 203 on the controller 20 is turned to the “Armed state” position. However there are two states that must be traversed automatically in order for the system to reach the Armed State. The first is the Pair Up phase and the second is the Trio Up phase.

### Pair Up Phase

The controller 20, in turn sends a message to each tag 10A, 10B, 10C, starting with tag 10A (tag 1) and requests that it broadcast a message on its lowest power, inviting any listening tag that has not already become associated to become its paired tag. The controller 20 waits a short period of time for a response from tage number 1 (the tag 10A). If none is received, then it moves on to the next tag in its list, tag 10B (number 2) and so on. If a suitable unpaired tag, for example tag 10C (number 3), responds to the signal from tag 10A, then the tag 10A confirms the pairing to the tag 10C and reports its own ID and the ID of the tag 10C back to the controller 20, which responds with a Group ID for the pair of tags 1A, 10C. The tag 10A at this point effectively becomes a detector tag (as will be described further below). The controller stores this information and knows that tag 1 and tag 3 are paired and also stores information to ensure that neither of these tags are to be contacted again by the controller during the pairing process. For example, tag 10B (number 2) might be contacted next by the controller and, effectively, be invited to become a detector tag, but tag 10C (number 3) would not as it has already been recorded as being a paired tag in the tag 10A/10B pair.

Once the controller has contacted all tags in it's adopted group, whether they have responded and been paired or not, it enters the Trio Up phase.

In order to reduce transmission collisions, each tag 10 uses its adopted tag ID as a period to delay before responding to a potential detector tag. In this way, if tag 10A (number 1) was advertising for a tag to pair with and it was within range of tags 10B (number 2) and 10C (number 3), then it would most likely pair with tag 10B (number 2) which would have responded after, say 2 milliseconds, whereas tag 10C (number 3) would have responded after 3 milliseconds. The same anti-collision algorithm is used in the Trio Up tag negotiations.

### Trio Up Phase

The Trio Up state does not actually produce groups of three tags as all groups in the example system are pairs. However, in the case that there are an odd number of tags in proximity to each other, a tag (in this case tag 10B) that has not been reported to the controller 20 as part of a pair in the Pair Up phase will be sent a message by the controller 20 inviting it to broadcast a low power message and any non-detector tag (in this case 10C) that was previously paired up with a detector tag (in this case 10A) will respond with a message and also become a tag to the previously unpaired detector tag 10B, effectively becoming the non-detector tag in two pairs, 10A/10C, 10B/10C.

The operation of this mode is identical to the Pair Up mode i.e. the controller 20 broadcasts to previously unpaired tags in turn, tags broadcast on low power, if a response is received, they confirm the pairing and then report theirs and their paired tag's ID back to the controller which confirms the grouping with a Group ID. In the case that no suitable tag is found, then the tag is simply not part of any group and is unable to participate in the monitoring process. This is considered a user error and may be reported either by a specific alarm state or signal or by a specific sequence of LED flashing, for example, and can only be rectified by disarming, physically relocating the tags and arming again.

### Armed State

Once all tags 10 are paired into detector-tag/non-detector-tag groups, the system enters the armed state. During this state, the controller 20 sends out a synchronisation message every 2 seconds. This is listened out for by all detector tags and non-detector tags and the message contains details of the state of the system (Disarmed, Armed, etc.), for example if the user has turned the system back to disarmed mode, a signal provides for all tags to re-enter that mode. It also serves as a baseline in time for the tags. Each tag pair was assigned a Group ID by the controller 20 when the detector tag of the group (pair) reported its pairing to the controller. These are sequentially numbered and identify a window of time whereby the respective detector tag measures the range to its paired tag and reports back with that range to the controller 20. The controller knows how many pairs it can sustain and equally divides the window between synchronisation pulses (which is approximately 2 seconds) into “max pairs” number of slots. Each pair was given a group ID when it reported it's pairing during Pair/Trio Up which corresponds to the window in which it can transmit.

If no report is received, it is assumed that the detector tag has been tampered with and a continuous alarm is sounded on the controller alarm 206. The alarm is serviced at every Synchronisation message sent out in Armed mode (i.e. every 2 seconds). The reports of the pairs are examined and any pairs that reported movement set an alarm flag. The Alarm buzzer is then activated until the user changes the system state to Disarmed mode using the keyswitch.

Within each group's window, the detector tag (10A in the first case of the present example) broadcasts a ping message simply a message from one tag to the other requesting a response (Pong) on its lowest power to its associated non-detector tag 10B, which responds with a pong if it can hear it. Should the non-detector tag 10B have been moved further away and out of (low power) range of the detector tag (which would typically be about 1 metre) at the lowest power level, then the detector tag would fail to hear a response message (Pong) from the non-detector tag 10B within the first third of their pair's time window and would increase it's power and re-transmit the Ping message. If the non-detector tag 10B can now hear on the higher power level, it increases its power and sends a response back. The detector tag 10A then reports back to the controller that some movement has taken place (either of the tags or in the ambient conditions affecting the tags, eg a tag being wrapped in metal foil) and the controller indicates this audibly by blipping the sounder alarm 206, but not sounding it continuously. At this point, this “amber” alert is reversible by moving the detector tag 10A and non-detector tag 10C back within low power range on the pair's next reporting window. If a pong is not received by the detector tag 10A in this higher power, second third, of the pair's reporting window, then the non-detector, paired, tag 10C has either been tampered with or moved so far out of range as to trigger the alarm. The detector tag 10A reports the alarm condition back to the controller using the reporting message in the final third of its reporting window.

The controller 20 then raises a continuous audible alarm which can be reset only by turning the system back to its disarmed state.

After the first group's (pair's) 10A, 10C, window, the next group's (pair's) 10B, 10C window is entered and that pair performs the same scan as described immediately above.

The idea behind the windows is to reduce transmission collisions and also to allow the tags in particular groups to “sleep” in a very low power consumption mode until either their reporting window, or the synchronisation pulse is reached.

If the key switch 203 is now turned to another state, this will be broadcast in the next synchronisation message and all tags will enter that state.

1. An RFID transceiver tag for use in a monitoring system for detecting a change in position of the tag relative to an associated RFID tag or the environment surrounding or between the tags, the transceiver tag comprising:
a detector for detecting a characteristic of a signal transmitted between the transceiver tag and the associated RFID tag and for creating a trigger signal if the detector detects that the characteristic has changed beyond a predetermined extent; and
a transmitter for transmitting a signal to a remote controller on receipt of the trigger signal from the detector.

2. An RFID transceiver tag according to claim 1, wherein the detector is arranged to vary the extent of change of the predetermined characteristic at which it creates the trigger signal.

3. An RFID transceiver tag according to claim 1, wherein the characteristic is the received power level of the signal.

4. An RFID transceiver tag according to claim 1, wherein the transceiver tag is arranged to monitor the characteristic of the signal from the associated RFID tag.

5. An RFID transceiver tag according to claim 1, comprising a second transmitter for transmitting a ranging signal to the associated RFID tag, and wherein the detector is arranged to detect the receipt of a signal from the associated RFID tag indicating that a characteristic of the ranging signal has changed beyond the predetermined extent.

6. An RFID transceiver tag according to claim 5, wherein the second transmitter is arranged to vary the characteristic of the ranging signal.

7. An RFID transceiver tag according to claim 6, wherein the characteristic of the ranging signal that is varied is the power at which it transmits the ranging signal to the associated tag.

8. A monitoring system for detecting a change in position of an item relative to another item or a change in the environment, the system comprising:
a first RFID transceiver tag comprising:
a detector for detecting a characteristic of a signal transmitted between the transceiver tag and the associated RFID tag and for creating a trigger signal if the detector detects that the characteristic has changed beyond a predetermined extent; and
a transmitter for transmitting a signal to a remote controller on receipt of the trigger signal from the detector; and
a second RFID tag arranged to transmit a signal to the first transceiver tag, and
wherein the detector of the first RFID transceiver tag detects a characteristic of the signal transmitted by the second RFID tag.

9. A monitoring system according to claim 8, including a controller arranged to detect receipt of the trigger signal from the first RFID transceiver tag and generate an alarm signal on receipt thereof.

10. A monitoring system according to claim 8, wherein the trigger signal is arranged to be received by the controller directly from the RFID transceiver tag.

11. A monitoring system according to claim 8, wherein the detector is arranged to report the alarm condition to the controller via another tag in the system when it cannot communicate directly to the controller due to the distances involved.

12. A monitoring system according to claim 11, wherein the controller is capable of setting up the system to allow indirect communication.

13. A monitoring system according to claim 8, further comprising at least one additional identical RFID tag.

14. A monitoring system according to claim 8, wherein:
the controller is switchable between first, second, third, fourth and fifth states;
the first state being an “off” state, the second state being one in which a first signal is broadcast to the RFID tags to cause an uninitialised tag within range of the controller to be initialised to a specific relationship with the controller, the third state being one in which initialised RFID tags are provided with system information by the controller, and the fourth state being one in which the controller provides a control signal in turn to each initialised RFID tag to cause the RFID tag to attempt to pair with another RFID tag;
the RFID tags being arranged such that, on receipt of the control signal from the controller, the RFID tag transmits a pairing signal and, if a pairing response signal is received from another RFID tag, confirms the pairing with the other RFID tag and to the controller, and such that on receipt of a pairing signal from a first RFID tag the other RFID tag transmits a pairing response signal to the first RFID tag, and thereafter, on receipt of the confirmation of pairing signal from the first RFID tag, switches to a state in which it will not respond to a control signal received from the controller, and thereafter the first RFID tag monitors for detection of a characteristic of a signal transmitted between the first RFID tag and the other RFID tag; and
the fifth state of the controller providing an armed state in which it monitors for receipt of the trigger signal from the first RFID tag of the or each pair of RFID tags.

15. A monitoring system for detecting a change in position of an item relative to another item, the system comprising:
a first RFID transceiver tag for use in the monitoring system for detecting a change in position of the tag relative to an associated RFID tag or the environment surrounding or between the tags, comprising:
a detector for detecting a characteristic of a signal transmitted between the transceiver tag and the associated RFID tag and for creating a trigger signal if the detector detects that the characteristic has changed beyond a predetermined extent; and
a transmitter for transmitting a signal to a remote controller on receipt of the trigger signal from the detector, wherein the first RFID transceiver tag is arranged to monitor the characteristic of the signal from the associated RFID tag; and
a second RFID tag having
a detector for detecting a characteristic of the ranging signal transmitted from the first RFID transceiver tag to the second RFID tag and for creating a sensing signal if the detector detects that the characteristic has changed beyond a predetermined extent, and
a transmitter for transmitting the sensing signal to the first RFID transceiver tag on receipt of the trigger signal from the detector, and
wherein the detector of the first RFID transceiver tag is arranged to create the trigger signal on receipt of the sensing signal.

16. A monitoring system according to claim 9, including a controller arranged to detect receipt of the trigger signal from the first RFID transceiver tag and generate an alarm signal on receipt thereof.

17. A monitoring system according to claim 9, wherein the trigger signal is arranged to be received by the controller directly from the RFID transceiver tag.

18. A monitoring system according to claim 9, wherein the detector is arranged to report the alarm condition to the controller via another tag in the system when it cannot communicate directly to the controller due to the distances involved.

19. A monitoring system according to claim 18, wherein the controller is capable of setting up the system to allow indirect communication.

20. A monitoring system according to claim 9, further comprising at least one additional identical RFID tag.

21. A monitoring system according to claim 9, wherein:
the controller is switchable between first, second, third, fourth and fifth states;
the first state being an “off” state, the second state being one in which a first signal is broadcast to the RFID tags to cause an uninitialised tag within range of the controller to be initialised to a specific relationship with the controller, the third state being one in which initialised RFID tags are provided with system information by the controller, and the fourth state being one in which the controller provides a control signal in turn to each initialised RFID tag to cause the RFID tag to attempt to pair with another RFID tag;
the RFID tags being arranged such that, on receipt of the control signal from the controller, the RFID tag transmits a pairing signal and, if a pairing response signal is received from another RFID tag, confirms the pairing with the other RFID tag and to the controller, and such that on receipt of a pairing signal from a first RFID tag the other RFID tag transmits a pairing response signal to the first RFID tag, and thereafter, on receipt of the confirmation of pairing signal from the first RFID tag, switches to a state in which it will not respond to a control signal received from the controller, and thereafter the first RFID tag monitors for detection of a characteristic of a signal transmitted between the first RFID tag and the other RFID tag; and
the fifth state of the controller providing an armed state in which it monitors for receipt of the trigger signal from the first RFID tag of the or each pair of RFID tags.
